(19) United States
(12) Patent Application Publication
(10) Pub. No.: US 2014/0081879 A1
(43) Pub. Date: Mar. 20, 2014

(54) SOCIAL MEDIA PARTICIPANT ECONOMIC BENEFIT SYSTEM AND METHOD

(71) Applicants: Lyndsie Lee Olson, Anaheim Hills, CA (US); Joseph C. Estes, JR., Chino Hills, CA (US); Joaquin Brown, Culver City, CA (US); Dave B. McLelland, Laguna Niguel, CA (US); DeAnna Carels, Laguna Beach, CA (US); Chris Tumer, Orange, CA (US)

(72) Inventors: Lyndsie Lee Olson, Anaheim Hills, CA (US); Joseph C. Estes, JR., Chino Hills, CA (US); Joaquin Brown, Culver City, CA (US); Dave B. McLelland, Laguna Niguel, CA (US); DeAnna Carels, Laguna Beach, CA (US); Chris Tumer, Orange, CA (US)

(21) Appl. No.: 13/621,201

(22) Filed: Sep. 15, 2012

(51) Int. Cl. G06Q 99/00

(52) U.S. Cl. 705/319

(57) ABSTRACT

A social media exchange center is disclosed to communicate likes between social media participants in exchange for economic benefits. The center includes categories of the social media participants created in accordance with a level of social participation between and among members of a group of social media participants. A location aware system monitors a location of at least one portion of the group of social media participants. An economic benefit system exchanges leads or tips on retailers products or services for economic benefits responsive to the location of the at least one portion of the group of social media participants between and among groups of social media participants in accordance with the level of social participation between and among the members of the group social media participants.

### PRIORITY AND RELATED APPLICATION(S)

This U.S. non-provisional utility patent application is co-pending with, claims priority to, and incorporates by reference in its entirety U.S. non-provisional utility non-provisional patent application entitled “WIRELESS MODILE COMMUNICATION SYSTEM REWARDS ROYALITY SYSTEM AND METHOD” Ser. No. 12/477,117 filed on May 22, 2012; claims priority to and incorporates by reference in its entirety U.S. non-provisional utility patent application entitled “LOCATION DETERMINATION SYSTEM AND METHOD USING ARRAY ELEMENTS FOR LOCATION TRACKING” Ser. No. 13/349,565, filed on Jan. 13, 2012, incorporates by reference in its entirety U.S. non-provisional utility patent application entitled “SIGNAL RESET CIRCUIT FOR WIRELESS COMMUNICATION SYSTEMS” Ser. No. 13/349,561 filed on Jan. 13, 2012; claims priority to and incorporates by reference in its entirety U.S. non-provisional application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 filed on Dec. 4, 2011, claims priority to and incorporates by reference in its entirety co-pending U.S. Utility patent application Ser. No. 13/010,437 filed on Jan. 20, 2011; and claims priority to and incorporates by reference in its entirety co-pending U.S. Utility patent application Ser. No. 12/831,471 filed on May 22, 2012 and is co-pending with and claims priority to “CONTENT MANAGEMENT SYSTEM AND METHOD” Ser. No. ______ having the same inventors as this application and filed concurrently with this application.

### BACKGROUND

1. Field of the Disclosure

This disclosure relates generally to the field of social media networks, and specifically in one exemplary aspect to social media system and method employing profiles and associations of its participants to improve advertisements and marketing efforts in a location centric manner by retailers of products and services.

2. Description of Related Technology

Social media networks are very fast growing and popular among a growing sector of the population. Social media networks help others stay in touch with friends, family and make many other social relationships that would not otherwise be possible. For instance on a global scale, through social media networks, others can interact with and play computer games between individuals in cities or even countries that are thousands of miles apart and share culture and likes and dislikes. Participants can meet others in a safe setting, and test the water so as to evaluate a type and level of interaction that is best on an individual basis and on a group level. Through social media networks, the sharing of ideas and concepts is ramped-up. The concept of sharing information and “going viral” is made possible by many video posting website, e.g. You Tube. In yet another example, participants may post what's happening in their lives and what they experiencing on social medial network pages, including Facebook and Twitter. As such, participants feel free to express themselves and help others at the same time.

However, there are still other possibilities for improvements on social media networks processes and apparatuses that permit further sharing of information, i.e., provide marketing and provide a forum to test and adapt learning or modeling algorithms, to improve real-time sharing and help others with their daily lives, which minimizes the required labor and/or time from initially obtaining information to the processing and subsequent sharing or posting of these ideas. Such improved apparatus and methods would ideally minimize labor-intensive tasks of Internet postings and be part of an automatic or semi-automatic algorithm and structure. Furthermore, it would be advantageous for an improved process or system to provide multiple configurations, and thus permit the creation of user-customized sharing configurations using one or more structures or components and software routines.

### SUMMARY

In one aspect, a social media exchange center is disclosed to communicate likes between social media participants in exchange for economic benefits, the center including: categories of the social media participants created in accordance with a level of social participation between and among members of a group of social media participants, a location tracking system that monitors a location of one or more mobile communication devices of at least one portion of the group of social media participants; and an economic benefit system that exchanges leads or tips on the products or services of commercial participants and others for economic benefits responsive to the location of the at least one portion of the group of social media participants between and among groups of social media participants in accordance with the level of social participation between and among the members of the group social media participants.

In yet another aspect, a method for a social media exchange center is disclosed to communicate likes in exchange for economic benefits, the method including: categorizing social media participants in accordance with a level of social participation between and among members of a group of social media participants; monitoring a location by a location tracking system of at least one portion of the group of social media participants; and exchanging leads and tips on the products or services of commercial participants and others for economic benefits responsive to the location of the at least one portion of the group of social media participants between and among groups of social media participants in accordance with the level of social participation between and among members of the group social media participants and a level of commercial participant participation with the location.

These and other embodiments, aspects, advantages, and features of the present disclosure will be set forth in part in the description which follows, and in part will become apparent to those skilled in the art by reference to the following description of the disclosure and referenced drawings or by practice of the disclosure. The aspects, advantages, and features of the disclosure are realized and attained by means of the instrumentalities, procedures, and combinations particularly pointed out in the appended claims.

### BRIEF DESCRIPTION OF THE DRAWINGS

FIG. 1 illustrates a social media exchange center in accordance with an embodiment of the present disclosure;

FIG. 2 illustrates an exemplary social media network including social media participants and commercial participants in accordance with an embodiment of the present disclosure;

FIG. 3 illustrates an exemplary social media network including commercial participants in accordance with an embodiment of the present disclosure;

FIGS. 4 and 5 illustrates exemplary systems using a bluetooth module, a Wi-Fi module, an ultrasound controller, sound transceiver units, a phased array module and/or location tags or data tags, e.g., ID tags, for distancing objects and obtaining information about social media network including a social media participants and commercial participants within a room or location in accordance with the present disclosure; and

FIG. 6 illustrates a flow diagram of a social media exchange center in accordance with an embodiment of the present disclosure.

### DETAILED DESCRIPTION

Reference is now made to the drawings wherein like numerals refer to like parts throughout.

### Overview

In one salient aspect, the present disclosure discloses apparatuses and methods for assisting others in consumer purchases, likes or consumer transactions related to, inter alia, retailer sources including big box retailers. In particular, the present disclosure discloses an apparatus and method configurable to assist social media participant, e.g., consumer, user of a mobile communication device, and commercial participant, e.g., retailer of products and services, a business or company engaged in distribution, sales of consumer products and services, a business engaged in advertisements of consumer and retail products and services for a profit, product or service center. In one example, commercial participant evaluates a method for initiating and generating advertisements that communicate new products or services. Furthermore, the present invention further discloses a technique for accurately portraying in real-time, likes associated with positive feeling transactions identified, such as recently purchased items while collecting empirical data associated with groups of participants in a convenient database, with selected profiles or categorical information highlighted or displayed or assessable in a non-distracting manner.

In addition, the apparatus, method, and system of the present disclosure advantageously allows a more intuitive method to view likes and other attributes associated with consumer transactions in real-time situations where other reviews and operations management may not detect these products or services in a centric location fashion until months after a consumer transaction has been completed. For instance, with this invention, not only can a user within a real-time generated referral report discover proximal location for future transactions, but he/she also can distinguish physical and empirical characteristics of the transactions, e.g., location of the transaction, type of merchant, frequency of the transaction, amount of spending at a particular establishment and relate this a consumers profile or categories of retailers. As such, the apparatus thereby allows a user's brain to more intuitively distinguish signals of future consumer details including new trends and really cool experiences, even before one or more credit card transactions occur or are contemplated by a consumer.

In addition, the apparatus advantageously provides the ability to preserve database information, e.g., create a consumer database, from different sources and attaches and adjusts indicators and details of transactions into a more natural format, and to centrically maintain direct evidence of new trends of one or more villages of social media participants.

Advantageously, in one embodiment, database algorithm(s) improve(s) the detection of consumer transactions when purchasing from merchants that are of a different type or kind thereof from that of the historical transactions. Advantageously, in one embodiment, the system improves a user's ability to distinguish details of transactions and other finer features that could not otherwise be seen using conventional software or apparatus. Furthermore, one or more routines of one embodiment unobtrusively highlight a potential for improved transaction information availability for agencies to utilize in evaluating likelihood of successful consumer transactions.

In addition, the improved process or system would assist in informing others on a global scale of retailers products and services and thereby potentially reduce a number or magnitude thereof of returns by consumers, frustration by consumers with multiple products and services that cover the same or similar issues, and as such, provide a consumer a more informed, direct, and information and market centric system for sharing information such as over a social media network and perhaps provide one or more rewards to participants for their efforts.

As used herein, the term “wireless” refers to wireless communication to a device or between multiple devices. Wireless devices may be anchored to a location and/or hardwired to a power system, depending on the needs of the business, venue, event or museum. In one embodiment, wireless devices may be enabled to connect to Internet, but do not need to transfer data to and from Internet in order to communicate within a wireless information communication and delivery system;

In addition and as used herein, the term “Smart Phone(s)” or “smart phone(s)” or “mobile communication device(s)” refers to a wireless communication device(s), that includes, but not is limited to, an integrated circuit (IC), chip set, chip, system-on-a-chip including low noise amplifier, power amplifier, Application Specific Integrated Circuit (ASIC), digital integrated circuits, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, RSSI (Relative Signal Strength Indicator), one or more indications of signal strength to data tags, e.g., identification tags or ID tags, within an area or room that communicate between mobile communication device(s) and one or more information repositories, for instance, including information servers including information about commercial participants' products or services, a bus line, an antenna to transmit and receive signals, and power supply such as a rechargeable battery or power storage unit. The chip or IC may be constructed (“fabricated”) on a “die” cut from, for example, a Silicon, Sapphire, Indium Phosphide, or Gallium Arsenide wafer. The IC may be, for example, analogue or digital on a chip or hybrid combination thereof. Furthermore, digital integrated circuits may contain anything from one to thousands or millions of signal invertors, and logic gates, e.g., “and”, “or”, “nand” and “nor gates”, flip-flops, multiplexors, etc., on a square area that occupies only a few millimeters. The small size of, for instance, IC's allows these circuits to provide high speed operation, low power dissipation, and reduced manufacturing cost compared with more complicated board-level integration;

As used herein, the term “location information” refers without limitation to any set or partial set of integer, real and/or complex location data or information such as longitudinal, latitudinal, and elevational positional coordinates, x, y, z coordinates within a location or relative location coordinates to one or more objects, Wi-Fi networks, and wireless communication devices;

As used herein, the terms “wireless data transfer,” “wireless tracking and location system,” “positioning system” and “wireless positioning system” refer without limitation to any wireless system that transfers data or communicates or broadcasts a message, which communication may include location coordinates or advertisements using one or more devices, e.g., wireless communication devices;

As used herein, the terms “module” or “modules” refer without limitation to any software, firmware, or actual hardware or combination thereof that has been added on, downloaded, updated, transferred or originally part of a larger computation or transceiver system that assists in or provides computational ability including, but not limited to, logic functionality to assist in or provide communication broadcasts of commands or messages, which communication may include location coordinates or advertisements between, among, or to one or more devices, e.g., wireless communication devices;

As used herein, the term “lead’ refers to without limitation to a recommendation, an introduction, direction, or guide to show a way to proceed in advance, or a positive indication concerning a commercial participants' products or services and

As used herein, the term “tip” refers to without limitation to any phrase or expression of value, any information provided by anyone to anyone else, economic benefit that is provided to anyone as a way of rewarding them.

### Exemplary Apparatus, System, and Method

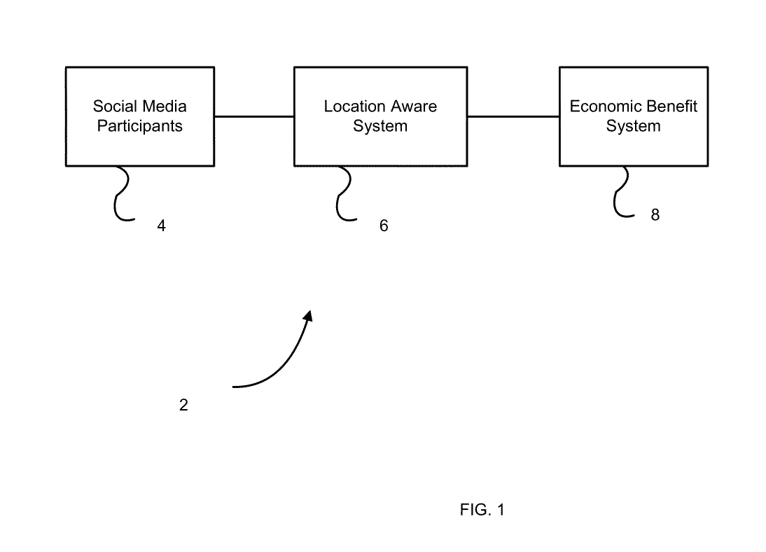

Referring to FIGS. 1-6, exemplary embodiments of the apparatus, system, and methods of the invention are described in detail. It will be appreciated that while described primarily in the context of a social media exchange center system and apparatus, there are at least portions of the apparatus and other methodology for configuring the apparatus, system, and methodology described herein that may be used for other applications or purposes.

For example, it will be recognized that the present disclosure may use to create consumer transactions models and retailers product or services coding charts that indicate history and probability of future purchases or likes. Other functionality or applications of the present invention may include assistance in clearance processing of retail and commercial application(s), new product trends, determination of type and line of credit to provide a prospective consumer, security monitoring of present consumer transactions, loan application processing and clearance processing, and the like. As such, a myriad other functions will be recognized by those of ordinary skill given the present disclosure.

### Social Media Exchange Center

Referring to FIG. 1, social media exchange center 2 is disclosed to communicate likes between social media participants 4 in exchange for economic benefits, e.g., financial incentives. Categories of social media participants 4 created in accordance with a level of social participation between and among members of a group of social media participants. Location aware system 6 monitors a location of one or more mobile communication devices of at least one portion of a group of social media participants. In one instance, location aware system 6 infers preferences, likes, and desires of each of at least one portion of the group of social media participants based on information relative to the location of a mobile communication device of one or more social media participants. Economic benefit system 8 exchanges leads or tips through the one or more mobile communication devices of retailers products or services for economic benefits responsive to the location of the at least one portion of a group of social media participants between and among groups of social media participants in accordance with a level of social participation between and among the members of the group social media participants. The members of a group of social media participants include best friends, friends, acquaintances, and business associates. In one example, location aware system 6 includes one or more data tags, e.g., ID tags, associated with the commercial participants' products or services available for viewing responsive to the location of one or more mobile communication devices by the at least one portion of the group of social media participants.

In one example, economic benefit system 8 includes tiered reward system that provides first economic, e.g., financial, monetary compensation, reward, perk, incentive for at least one member of a portion of the group of social media participants communicating one or more likes through the one or more mobile communication devices based on viewing the commercial participants' products or services to at least one other member of the portion of the group of the social media participants. In yet another example, a second economic, e.g., financial, monetary compensation, reward, perk, incentive, e.g., for example, which may be larger than the first economic incentive, upon a purchase likes of the commercial participant's products or services associated with the one or more likes. In one variant, the one or more likes include a member of the portion of the group of social media participants who owns, likes, or would like to own the commercial participants' products or services viewed. In another aspect, location aware system 6 retrieves the one or more likes and communicates one or more proximal locations for purchases or likes of commercial participant's products or services to selected at least one portion of group of social media participants that are participant associated with one or more likes.

### Social Media Participants Village Network(s)

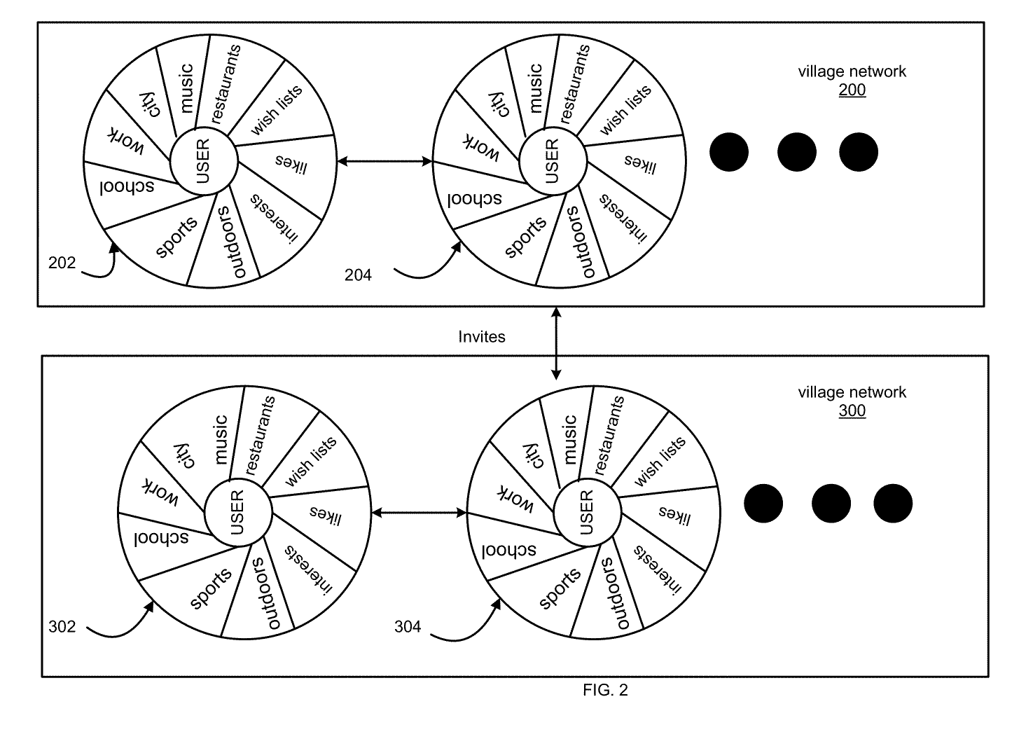

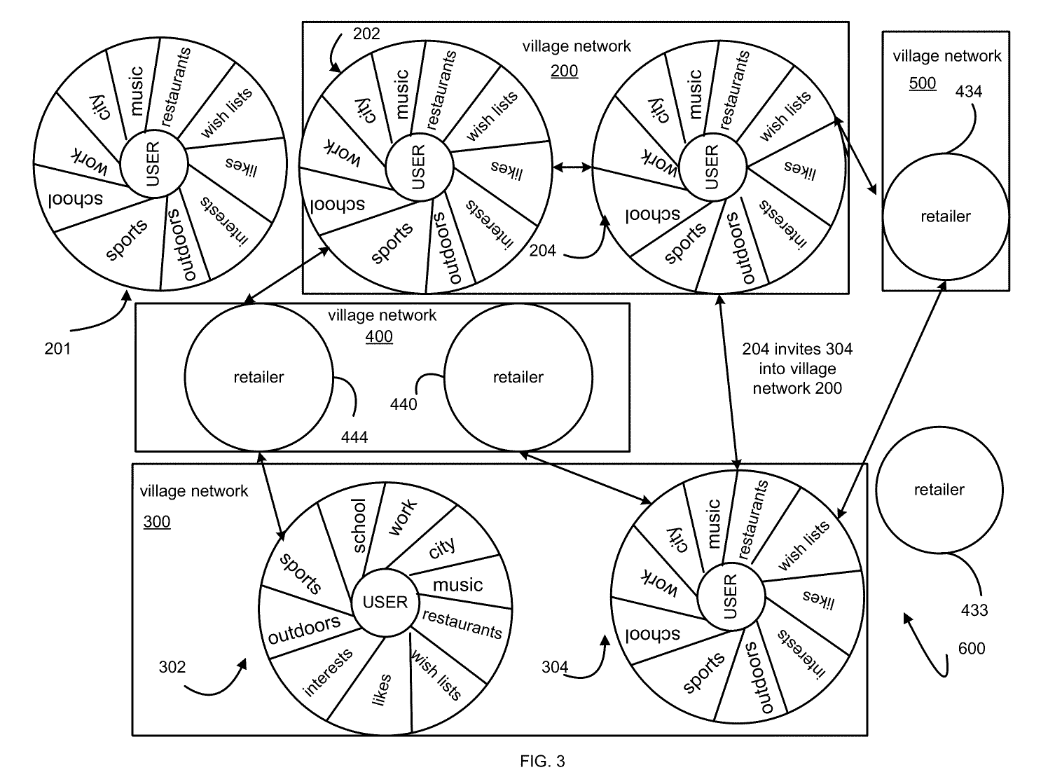

Referring now to FIGS. 2 and 3, a first exemplary example of system 2 is illustrated. Social media participants are categorized by one or more likes into one or more social media categories, e.g., best friends, friends, social acquaintances, wish lists, style, music, film, collectors, girlfriend(s), social partners, concerts, wine, food, and business acquaintances, and the like. Each of the social media participants may be categorized individually, e.g., social media participant 201 and/or categorized into one or more social media participant village network(s), e.g., village network(s) 200, 300. Social media participant village network(s) include groups of users, e.g., social media participant(s) 202, 204, with one or more common social media category based on one or more likes. For instance, social media participant village network 200 includes social media participants 202, 204 who have similar likes on multiple social media categories. For example, social media participants in village network 200 have one or more items in common, for example, likes, e.g., chocolate ice cream; wish lists, e.g., off-road pickups and/or trucks; restaurants, e.g., Italian sausage; music, e.g., female country western singers; city, e.g., Torrance; e.g., work, e.g., postal workers, bartenders, dancers; school, e.g., law school, engineering master's degree, nursing credentials, x-ray technician credentials; sports, e.g., Lakers, Clippers, college football; and outdoors, e.g., purchase months before winter lift season passes for snowboarding in Mammoth Mountain or Big Bear Lake; and interests, e.g., drama or action theater productions, and ballet lessons at dance studio.

On the other hand, social media participants 302, 304 of village network 300 have one or more items in common, for example, likes, e.g., skydiving, hang gliding, water polo, water aerobics; wish lists; e.g., off-road pickups and trucks; restaurants, e.g., local coffee shops; music, e.g., rock and roll; city, e.g., Palos Verdes; work, e.g., heavy equipment operator, fire truck personnel; e.g., school, welding technical school, performing art college; e.g., sports, Steelers, Raiders, San Diego Padres; outdoors, e.g., hiking; and interests, e.g., museum watching and skiing lessons. While shopping for products or services at one or more positions or locations, social media participants, e.g., social media participants 202, 204, 302, 304 of either or both village networks 200, 300 post pictures, recommendations, likes, and wish lists to their respective village network.

While at home, inside an area, or on the go, members of social media participants create shopping lists, wish lists, for example, for special events, e.g., birthdays, holidays, or other events those members, e.g., social media participants, desire or need. As such, while shopping at home, or on the go, members of social media participants create social shared experiences, for example, that may lead or blend into one or more media advertisements that may be used by retailers for products or services. In one example, members of social media participants of village networks 200, 300 link friends to one or more portions of each of the village networks 200, 300 so they can view pictures and receive likes, e.g., information from retailers on products and services, including museums, restaurants, events, and sporting outings.

When one member of the social media participants, for example, in one or more of village networks view(s) a retailers item that another has, for instance, in his/her wish list, then information on the item and location(s) near a mobile communication device of another member of social media participants are stored in one or more memory locations on the social media exchange center and/or may be communicated by electronic message, e.g., email, text, sms, or the like, when the information applies, e.g., based on a stored user profile, to the another member of the social media participants. Afterwards, an electronic message is generated, based on inputs from the other members of the social media participants, and referral persons, e.g., referral social media participant, shared on-line profile items, are sent to the other social medial participant to notify them, for example, who sent them the referral and any retailer specials for this item at a participating retailer in your current and/or home location.

In addition, when the other social media participant's location is proximal to the item, then a reminder electronic message may be sent to the other social media participant as a reminder about any prior interest in the item. When the item is viewed by the other social media participant, regardless of location, e.g., on-line, in person at the store based on location, a first economic benefit, e.g., a monetary commission, reward, perk or the like, is deposited into a recommender's account, e.g., recommender social media participant account, or otherwise credited to the recommender. Upon a like at a location, a second economic benefit, e.g., monetary commission or compensation, reward, perk or the like, is deposited into the recommender's account, e.g., recommender social media participant account or otherwise credited to the recommender.

Advantageously, information may be shared between social media participants based on location, e.g., relative location between social media participants, and items for purchase, e.g., shared on-line profile items. For example, relative location may be based on location of mobile communication device of the social media participant, items for purchase, e.g., shared on-line profile items, items based on user profile stored on a mobile communication device of a social media participant. As such, social media participants desires or requests from one or more on-line user profile are used to assist in maximizing desired purchase or obtaining items using current location of the social media participant as related to items, for example, on a wish list, for future purchases or likes.

Furthermore, by responding to posts, pictures, likes, or recommendations for products or services from recommenders from social medial participants of village networks 202, 204, a member of the social media participants receives one or more economic benefits, e.g., first or second economic benefits, or, in yet one variant, just a really cool experience. As such, a member of the social media participants interacts and engages socially with one or more businesses or services. In one variation, by posts, offers, rewards for members of social media participants that add a preference, e.g., desire to join, one or more retailer village network(s), e.g., retailer village network 400 including retailers 444, 440, and retailer village network 500 including retailer 434, a social media participant may be assisted to make a better buying decision and achieve an expedited path to purchase. For example, the expedited patch to purchase is based on sharing of information between commercial and social media participants and among social media participants.

### Commercial Participant Village Network(s)

Referring to FIG. 3, from the commercial participant(s), e.g., retailer(s), village networks, comments, trends and/or new products or service advertisements are directed by, e.g., electronically message, in a location centric manner, e.g., based on proximity of one or more retailers location to members of the social media participants that has added retailer village networks 400, 500 as a preference. In one variant, retailers connect one or more retailer village networks strategies or marketing techniques, e.g., in-store marketing strategy to one or more social media participants of one or more village networks based on, for instance, based on shopping or home wish lists or the like.

Members of social media participants, e.g., social participants 201, 202, 204, 302, 304 post or recommend likes, pictures, video, and, if part of a village network, may invite friends into their village network, e.g., social media participant village networks 200, 300. For the content management network, commercial participants, e.g., retailers 433, 434, 440, 444 speak out, e.g., post or upload pictures or reviews and if part of village network 400, 500 may speak out, e.g., post or upload pictures or reviews, to members of social media participants 201, 202, 204, 302, 304, for instance, based on one or more invites from users. For example, invites from commercial media participants, social media participants in a village network may include, without limitation, branding information so that social media participants may be connected to their favorite brands, and strengthen their relationship with these brands.

For example, favorite brands include products or businesses that a social media participant likes or has a positive experience, for example, stored on one or more user profile(s) in one or more memory devices accessible through their mobile communication device(s). As such, social media participants are provide an ability and opportunity to rate products and places. The rating system may be, for instance, a positive or negative symbol that signifies that social medial participant likes or dislikes an item or a location or an item at a location. As such, social media participants may be categorized in accordance with a level of social participation between and among members of a group of social media participants including, for instance, creating a village network that include the social media participants responsive to similar likes and desires and having an ability to invite other social media participants, e.g., social media participant 201, into one or more village networks, village network 200, 300.

Furthermore, social media participants may see or write reviews about a product or location or see other review and share categories of a village network. In one instance, social medial participants have an ability to invite friends to participate in a village network or add friends to a category in a village network.

### Location Aware System Including Social Media Participants Villages and Commercial Participants Villages

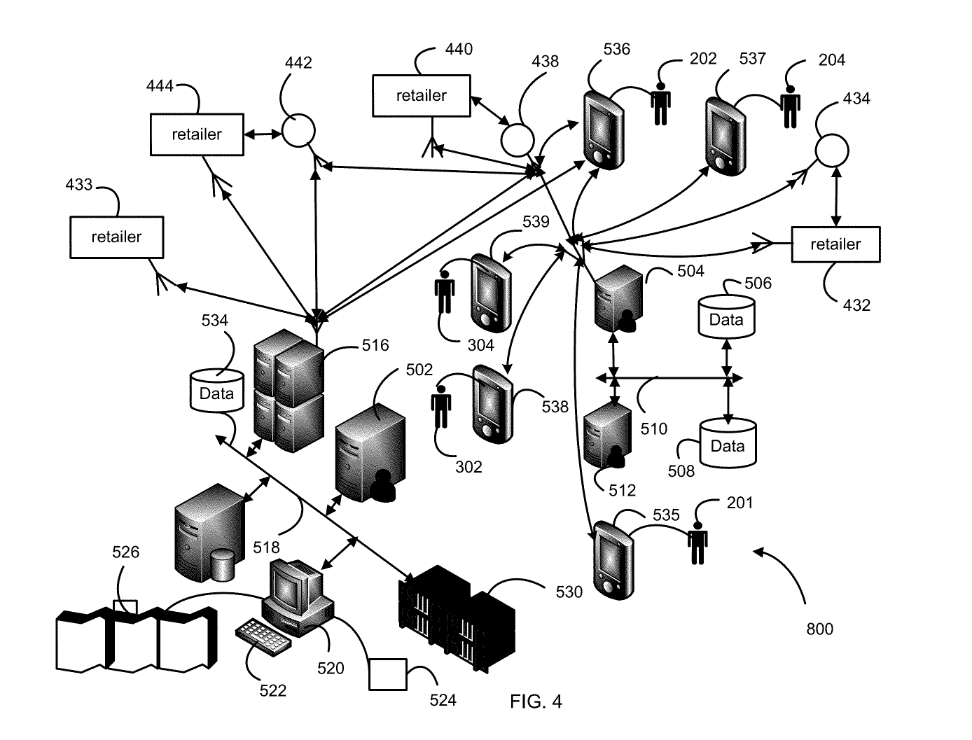

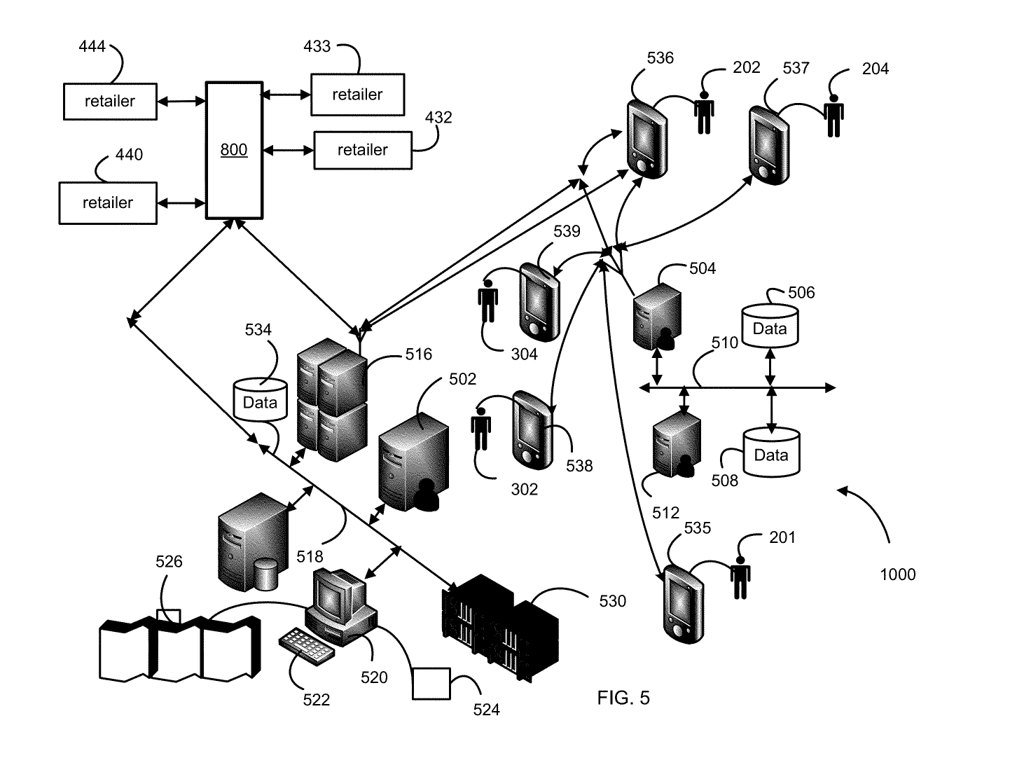

Referring to FIGS. 4 and 5, social media participants' location, e.g., past, current, and future (predicted), is monitored or tracked by using their mobile communication device, e.g., smart phone, location relative to one or more retailers locations. For example, future location may be based on past location on at a similar time of the day, e.g., play tennis every Sunday in Brea Calif. next to a local coffee shop that is located near the retailer's store. In yet another example, future location may be estimated based on current velocity.

Exemplary mobile cell phone tracking technologies are disclosed in the above incorporated by reference pending patents applications, which will be discussed supra in this disclosure. Location aware system involves matching of one or more social media participants reviews, postings, and/or user profiles including products and services based on location, e.g., past, current, and future (predicted) and remote management of available tracking technologies to improve accuracy of location tracking data.

As such, location aware system uses location tracking methodologies disclosed in any of the incorporated by reference and claimed priority to pending patent applications above to determine a location of mobile communication devices of social media participants. In one variant, location aware system may determine proximal accuracy, e.g., most repeatable measurements, of a location of each of the social media participants, for example, ones that are part of a village network by comparing physical parameters related to mobile communication device, e.g. relative signal strength, relative to one or more data tags in an area or location and/or commercial participants' products or services or information generated, for instance, by one or more tracking methods included in incorporated by reference patent applications, as relative to a changing or altered location of one or more items.

Exemplary location tracking technologies functionality and location determination for Smart Phone 1, Smart Phone 1, and data tags, e.g., identification tags or ID tags to identify and extract location information for mobile communication devices, e.g., Smart Phone 1, Smart Phone 2, and other wireless communication devices for instance, disclosed in FIGS. 4 and 5 of incorporated by reference patent applications, which a summary of each of their technologies are listed below:

Application Ser. No. 13/010,437 filed on Jan. 20, 2011, discloses a wireless information communication and delivery systems are described herein that includes at least one wireless-enabled device, a device location system, a positioning and communication system, and an information repository system. A configurable wireless protocol device is disclosed that includes a multi-modal transceiver that can establish a communication network with a local wireless-enabled device. A wireless network is described that includes: at least one configurable wireless protocol device; at least one wireless-enabled device; and at least one wireless access point. Methods of locating a wireless-enabled device are described and include: providing a wireless-enabled device, providing a configurable wireless protocol device comprising a modified wireless-protocol, and utilizing the configurable wireless protocol device to actively scan for the wireless enabled device;

Application Ser. No. 13/310,761 filed on Dec. 4, 2011, discloses a method that calculates a distance to objects or a nearest object to a wireless enabled device. The method includes the steps of broadcasting a signal by the wireless enabled device to data tags, receiving by the data tags the signal by the wireless enabled device, and obtaining by each of the data tags, e.g., ID tags, a signal strength indicator of the wireless enabled device based on the signal from the wireless enabled device. Each of the data tags, e.g., ID tags, in a range transmits a signal to the wireless enabled device including the signal strength indicator of the wireless enabled device. Each signal strength indicator of the wireless enabled device is communicated to a positioning and communication system;

Application Ser. No. 13/349,561 filed on Jan. 13, 2012 discloses a wireless network reset system. The system couples or connects to a power supply line. A microcontroller software module senses a signal from a Wi-Fi module that indicates a halting of a processor function. A reset module executes a reset based on the halting of the processor function;

Application Ser. No. 13/349,565 filed on Jan. 13, 2012, discloses a location based system. One or more phased array modules are configured to scan to determine a signal strength indicator of a signal broadcasted from at least one wireless mobile device within a distance area. Based on a signal strength indicator measured at multiple angular directions by the one or more phased array modules from the at least one wireless mobile device, a location of each wireless mobile device is determined within a room, building, or outside location; and

Application Ser. No. 13/477,117 filed on May 22, 2012, discloses a consumer-based purchase and referral rewards loyalty system. In the system, mobile communication devices include a location tracking devices. Data tags, e.g., ID tags, or other wireless communication devices are enabled to communicate with one or more mobile communication devices and to collect an identification code of each. Custom sales presentation module communicatively couples to the mobile communication devices and the data tags, e.g., ID tags, or wireless communication devices. Responsive to a locality of goods or services proximal to or predicted proximal to the location tracking devices, the custom sales presentation module generates a user specific sales presentation, which is sent to one or more mobile communication devices to advertise products or services.

Referring to FIGS. 4 and 5, systems 800 and 1000 disclose usage of respectively various location tracking systems disclosed in above referenced patent applications for determining, monitoring, and managing location information between social media participant(s) and commercial participant(s), e.g., retailer(s), as well as their respective village network location information. For example, location based system 800, disclosed in FIGS. 3 and 4, locating wireless enabled devices of social media participants having a mobile communication device, e.g., Smart Phone 1, Smart Phone 2, that broadcasts a signal within a distance and/or distance range of objects and/or data tags, e.g., ID tags 434, 438, 442, e.g., where individual functionality of mobile communication devices and data tags is illustrated, for example, in figures and associated text of the above referenced incorporated by reference pending patent applications.

Systems 800 and 1000 communicate, for instance, using communications server 516 by wired bus 518 or wireless means, such as Bluetooth or Wi-Fi, connectivity with private and public databases, though communications server 504, 512 having wireless capability accesses, for instance, information repository 506, 508 coupled to bus 510 and extracts information. For example, information extracted may be e.g., RSSI, from a nearby smart phone 536, for instance, Smart Phone 1 and Smart Phone 2, disclosed in incorporated by reference patent applications. Systems 800 and 1000 may include data storage hardware device 534 capable of storage of user data or user profile(s), e.g., preferences, interests, “perspectives” in the information system, relative coordinates, e.g., location coordinates, of smart phones 535, 536, 537, 538, 539 of respective users, e.g., social media participants 201, 202, 204, 302, 304 using a respective smart phones 535, 536, 537, 538, 539 relative distance to commercial participant, e.g., retailer 432, 433, 440, 444, or commercial participant's, e.g., retailer's, products or services and advertisements, as illustrated in systems 800, 1000, or Wi-Fi device or data tags, e.g., ID tags 442, 434, 438, illustrated in FIG. 4 associated with or closest to the object as illustrated in system 800.

For example, a particular item or location, e.g., as well as other information, for instance, uploads and reviews pictures of retailers products or services relative to a location or distance from one or more of data tags, e.g., ID tags 442, 434, 438, that are referenced, for instance, respectively to retailer 444, 432, 440 in their advertisements or other components on a temporary, transitory, or permanent basis. Application server 502, e.g., a distributed cluster of computer servers, stores executable software program code, for instance, RSSI signal strength calculation or User Datagram Protocol (UDP) algorithms in a semi-transitory or non-transitory software media capable of transferability using communications server 516 to transmit wired or wirelessly from processor unit 524. For example, processor unit 524 communicatively coupled to computer 520 that has a keyboard 522 to allow, for instance, user to provide remote inputs or direct inputs, for example, if user, e.g., social media participant 201, 202, 204, 302, 304, retailer 433, 444, 440, 432 products or services or representative, or the like are within range, for instance, by proximal physical location or remotely by wirelessly signaling, of keyboard 522.

As such, FIG. 4 is an exemplary system using one or more tags, e.g., ID tags, within an area to locate by obtain the signal strength indicator, e.g., RSSI, of the at least one wireless mobile device. In one instance, advertisement, lead, or tip module configured to direct one or more advertisements, leads, or tips including social media participant reviews, pictures, and uploads to one or more data tags, e.g., ID tags 439, 44 and by electronic message communicated to one or more village networks based on user profile or preferences list, e.g., preferences list 837 disclosed in incorporated by reference patent applications. In one example, one or more data tags, e.g., ID tags 442, 438, 434, are associated with items or consumer items of a particular type or groupings of one or more brands in shopping arena of, for example, products and/or services of retailer 432. In another variant, signal strength indicator, e.g., RSSI, includes a relative magnitude of a transmitted signal for each wireless mobile device of users, e.g., social media participants, within area of, for example, of retailer 432 products and/or services.

### Social Media Exchange Methodology

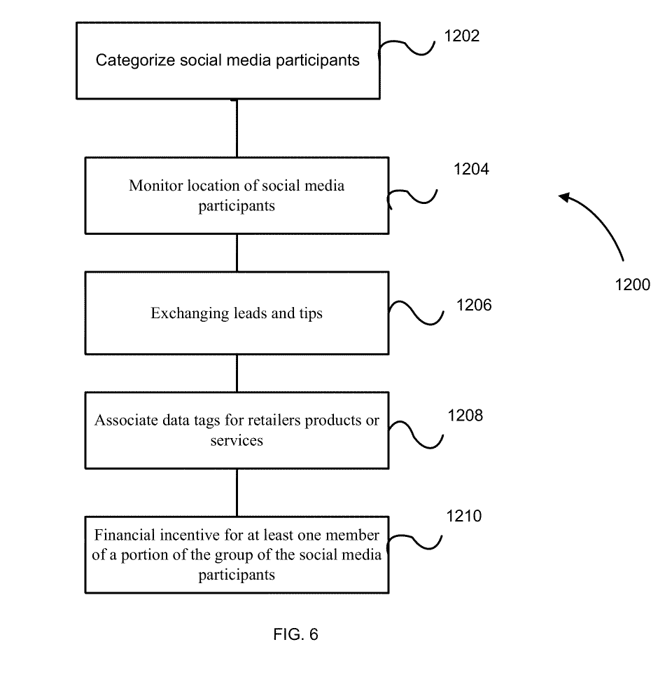

Referring to FIG. 6, a method 1200 is disclosed for a social media exchange center to communicate information transfers such as, without limitation, likes, actions, recommendations, and rewards, in exchange for economic benefits, e.g., economic incentives. The method 600 includes the steps of categorizing social media participants in accordance with a level of social participation between and among members of a group of social media participants (step 1202). In one example, the method includes creating the members of a group of social media participants to include best friends, friends, acquaintances, and business associates.

In addition, the method may include monitoring a location by a location tracking system of at least one portion of the group of social media participants (step 1204). In addition, the method may include exchanging leads or tips, e.g., uploads of pictures or reviews by social media participants, on commercial participants' products or services for economic benefits, e.g., economic incentives, financial incentives, responsive to the location of one or more mobile communication devices of the at least one portion of the group of social media participants between and among groups of social media participants in accordance with the level of social participation between and among members of the group social media participants and a level of commercial participant, e.g., retailer, participation with the location (step 1206). In addition, the method may include the step of associating one or more data tags, e.g., ID tags, associated with the commercial participants', e.g., retailers, products or services available for viewing by the at least one portion of the group of social media participants (step 1208).

In addition, the method may include implementing a tiered reward system as part of the economic benefits, the economic benefit, e.g., financial incentive, include a first economic benefit for at least one member of a portion of the group of social media participants communicating one or more likes based on viewing the retailers products or services to at least one another member of the portion of the group of the social media participants (step 1210). In one variant of step 610, the method may include implementing a second economic benefit upon a like or purchase of the commercial participant's products or services associated with the one or more likes.

In addition, the one or more likes include a member of the portion of the group of social media participants who owns, likes, or would like to own the commercial participants' products or services viewed. In yet another variant, retrieving by the location tracking system of the one or more likes and communicates one or more proximal locations for purchases or likes of commercial participant's products or services to selected of one or more mobile communication devices at least one portion of the group of social media participants that are participant associated with the one or more likes as related to location of products and services and uploads of reviews, pictures, and text of commercial participants' products and services based on location.

While the above detailed description has shown, described, and pointed out as novel features of the invention as applied to various embodiments, it will be understood that various omissions, substitutions, and changes in the form and details of the device or process illustrated may be made by those skilled in the art without departing from the invention. The foregoing description includes a best mode presently contemplated of carrying out the disclosure. This description is in no way meant to be limiting, but rather should be taken as illustrative of the general principles of the disclosure.

We claim:

1. A social media exchange center to communicate likes between social media participants in exchange for economic benefits, the center comprising:
categories of the social media participants created in accordance with a level of social participation between and among members of a group of social media participants;
a location aware system that monitors a location of one or more mobile communication devices of at least one portion of the group of social media participants; and
a economic benefit system that exchanges leads or tips on retailers products or services for economic benefits responsive to the location of the one or more mobile communication devices of the at least one portion of the group of social media participants between and among groups of social media participants in accordance with the level of social participation between and among the members of the group social media participants.

2. The center of claim 1, wherein the members of a group of social media participants include best friends, friends, acquaintances, and business associates.

3. The center of claim 1, wherein the location aware system includes one or more ID tags associated with the retailers products or services available for viewing responsive to the location of the one or more mobile communication devices of the at least one portion of the group of social media participants.

4. The center of claim 1, wherein the economic benefit system includes a tiered reward system that provides a first financial incentive for at least one member of a portion of the group of social media participants communicating one or more likes based on viewing commercial participants' products or services to at least one another member of the portion of the group of the social media participants.

5. The center of claim 4, further comprising a second financial incentive upon a purchase or like of the commercial participants' products or services associated with the one or more likes.

6. The center of claim 4, wherein the one or more likes include a member of the portion of the group of social media participants who owns, likes, or would like to own the commercial participants' products or services viewed.

7. The center of claim 3, wherein the location aware system retrieves the one or more likes and communicates one or more proximal locations for purchases or likes of commercial participants' products or services to a location of the one or more mobile communication devices of at least one portion of the group of social media participants that are participant associated with the one or more likes.

8. A method for a social media exchange center to communicate likes in exchange for economic benefits, the method comprising:
categorizing social media participants in accordance with a level of social participation between and among members of a group of social media participants;
monitoring by a location aware system a location of one or more mobile communication devices of at least one portion of the group of social media participants; and
exchanging leads and tips on commercial participant's products or services for economic benefits through the one or more mobile communication devices of at least one portion of the group of social media participants responsive to the location of the at least one portion of the group of social media participants between and among groups of social media participants in accordance with the level of social participation between and among members of the group social media participants and a level of commercial participant participation with the location.

9. The method of claim 8, further comprising creating the members of a group of social media participants to include best friends, friends, acquaintances, and business associates.

10. The method of claim 8, further comprising associating one or more ID tags associated with the commercial participants products or services available for viewing by the at least one portion of the group of social media participants.

11. The method of claim 8, further comprising implementing a tiered reward system as part of the economic benefits, the economic benefits include a first financial incentive for at least one member of a portion of the group of social media participants communicating one or more likes based on viewing commercial participants' products or services to at least one another member of the portion of the group of the social media participants.

12. The method of claim 11, further comprising implementing a second financial incentive upon a purchase or likes of the commercial participants' products or services associated with the one or more likes.

13. The method of claim 8, wherein the one or more likes include a member of the portion of the group of social media participants who owns, likes, or would like to own commercial participants' products or services viewed.

14. The method of claim 8, further comprising retrieving by the location aware system of the one or more likes and communicates one or more proximal locations for purchases or likes of the commercial participant products or services to selected at least one portion of the group of social media participants that have a participant associated with the one or more likes.

15. The method of claim 8, wherein categorizing social media participants in accordance with a level of social participation between and among members of a group of social media participants includes creating a village network that include the social media participants that have similar likes or desires; and inviting other social media participants into the village networks.

16. The method of claim 8, comprising communicating by social media participants uploads and reviews of commercial participant products and services based on proximal location to other social media participants based on a wish lists of the other social media participants.

17. The method of claim 8, wherein the commercial participants include retailers.

18. The method of claim 8, wherein the groups of social media participants are users associated with one or more village networks that include one or more social media participants that have one or more common interests or likes.
